(19) United States
(12) Patent Application Publication
(10) Pub. No.: US 2014/0324989 A1
(43) Pub. Date: Oct. 30, 2014

(54) GENERATING A GRAPHIC MESSAGE IN INSTANT MESSAGING

(71) Applicant: Xiao Long Zhang, Shenzhen (CN)

(72) Inventor: Xiao Long Zhang, Shenzhen (CN)

(21) Appl. No.: 13/993,618

(22) PCT Filed: Apr. 28, 2013
(86) PCT No.: PCT/CN2013/074967

§ 371 Date: Jun. 12, 2013

(51) Int. Cl. H04L 12/58

(52) U.S. Cl. CPC H04L 51/04
USPC 709/206

(57) ABSTRACT

In a method for generating a graphic message in instant messaging (IM), receiving, by an IM server, content inputted by an IM user; determining, by the IM server, user type of the IM user; selecting, by the IM server, a graphic message template from a database of the IM server according to the user type of the IM user; and generating, by the IM server, a graphic message to be distributed according to the selected graphic message template and the content inputted by the IM user.

### FIELD

The present disclosure relates to instant messaging techniques, and more specifically, to a method and an apparatus for generating a graphic message in instant messaging.

### BACKGROUND

Instant Messaging (IM) is a form of communication over the Internet that offers quick transmission of messages from sender to receiver. It may address point-to-point communications as well as multicast communications from one sender to many receivers.

More advanced instant messaging allows enhanced modes of communication, such as live voice or video calling, video chat and inclusion of hyperlink to media.

At present, some instant messaging provides a public platform for users. Companies, brands and celebrities may register on the public platform to have a public account (or referred to as official account) to communicate with their customers and fans directly. For example, WeChat (Weixin) has released a public platform for users to register public account. After registering on the public platform, the user gets a public account. Through the public platform of WeChat, venders may sell stuff or send news update, discount voucher, campaign announcement to their customers via graphic messages (also referred to as private users) on WeChat. The graphic message may include image, text, video, voice, link, etc.

### SUMMARY

Various examples of the present disclosure provide a method and an apparatus for generating a graphic message in instant messaging.

According to one example of the present disclosure, a computer-implemented method for generating a graphic message in instant messaging includes:

receiving, by an IM server, content inputted by an IM user;

determining, by the IM server, user type of the IM user;

selecting, by the IM server, a graphic message template from a database of the IM server according to the user type of the IM user; and

generating, by the IM server, a graphic message to be distributed according to the selected graphic message template and the content inputted by the IM user.

According to another example of the present disclosure, a server for generating a graphic message in instant messaging includes: a processor, a memory and a database, wherein the memory and the database are coupled to the processor, the database stores at least one graphic message template, the memory stores machine readable instructions executable by the processor to:

receive content inputted by an IM user;

determine user type of the IM user;

select a graphic message template from the database according to the user type of the IM user; and

generate a graphic message to be distributed according to the selected graphic message template and the content inputted by the IM user.

According to another example of the present disclosure, a non-transitory computer-readable storage medium storing one or more programs, which when executed by a processor, perform the steps of:

receiving, by an IM server, content inputted by an IM user;

determining, by the IM server, user type of the IM user;

selecting, by the IM server, a graphic message template from a database of the IM server according to the user type of the IM user; and

generating, by the IM server, a graphic message to be distributed according to the selected graphic message template and the content inputted by the IM user.

The method and apparatus provided by various examples of the present disclosure beneficially allows an IM user to generate a message conveniently. Thus, the IM user is released from the complicated image processing and design works. The experience of the IM user is improved.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network computer system 100 for generating a graphic message in accordance with an example of the present disclosure.

FIG. 2 illustrates a public platform interface 114 displayed on a client device 110 in accordance with an example of the present disclosure.

FIG. 3 illustrates an input interface 300 in accordance with an example of the present disclosure.

FIG. 4 is a block diagram illustrating a method for generating a graphic message in accordance with an example of the present disclosure.

FIG. 5A illustrates a graphic message template in accordance with an example of the present disclosure.

FIG. 5B illustrates another graphic message template in accordance with an example of the present disclosure.

FIG. 6 is a schematic diagram illustrating the structure of the server 140 in accordance with an example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Aspects of the present disclosure are described herein with reference to flowchart illustrations and/or block diagrams of method, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable processing apparatus or other devices to produce a computer implemented process such that the instructions which execute on the computer or other programmable apparatus provided processes for implementing the functions/acts specified in the flowchart and/or block diagram block or blocks.

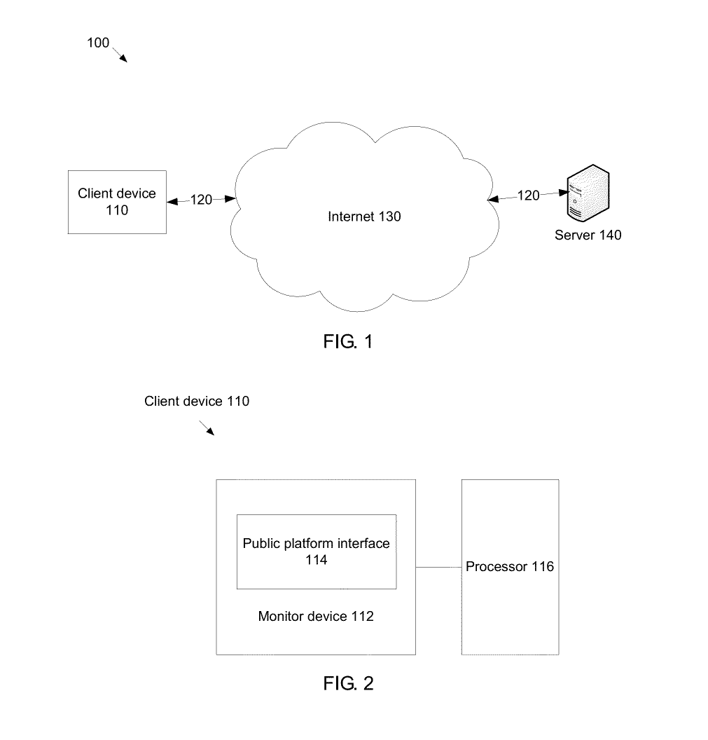

Referring now to FIG. 1, a network computer system 100 for generating a graphic message in instant messaging in accordance with an example of the present disclosure comprises: a server 140; a client device 110; and the Internet 130. The client device 110 may be a smartphone, a Personal Digital Assistant, a desktop computer or a laptop computer. Additionally, other devices such as netbooks, handheld and palmtop devices may also be deployed as the client device 110.

The client device 110 is connected or coupled via a link 120 to the Internet 130.

The client device 110 includes communication software to enable a user to access the server 140 through an IM application installed in the client device 110 or an IM public platform provided by the server 140. In various examples of the present disclosure, a public user accesses the server 140 through the public platform, whereas a private user accesses the server 140 via the IM application installed in the client device 110.

The server 140 may support IM services, i.e., allow users to send and receive IM messages. The server 140 may support other services related to IM.

Link 120 represents any suitable communication link or similar communication mechanism including some combination of a hardwired connection, an internal or external bus, a connection for telephone access via radio, infrared or other wireless communication methodologies (i.e., “Wi-Fi” or “Wi-max”, “Bluetooth”, infrared, etc.), private or proprietary local area networks (LANs) and wide area networks (WANs), as well as standard computer network communications over Internet 130 or an internal network (e.g., “intranet”) via a wired or wireless connection, or any other suitable connection between computers and computer components known to those skilled in the art, whether currently known or developed in the future.

In addition to the other components shown in FIG. 1, a wireless communication access device may be communicatively coupled to link 120 and may be any wireless communication mechanism that is known to those skilled in the art to provide wireless communication between the Internet 130 and the client device 110 associated with the Internet 130. In various examples of the present disclosure, an acceptable wireless communication access device may comprise any type of wireless access point, wireless bridge, wireless router, or similar type of device (no shown in FIG. 1).

Server 140 in FIG. 1 represents a computer system that is made available to the client device 110 via link 120 and the Internet 130. Various hardware components (not shown in FIG. 1) such as external monitors, keyboards, mice, tablets, hard disk drives, magnetic tapes, and other devices may be used in conjunction with server 140.

The server 140 may include a user profile server (not shown) connected to a database (not shown) for storing large amounts of user profile data. The user profile server may be used to enter, retrieve, edit, manipulate or otherwise process user profile data. In one implementation, a user's profile data includes, for example, user name, buddy list, geographic location, interests, etc. IM users of the client device 110 may enter, edit and/or delete profile data through the public platform.

Server 140 may also provide various additional software components (not shown in FIG. 1) such as database servers, web servers, firewalls, security software, and the like. The use of these various hardware and software components is well known to those skilled in the art. In at least one preferred example, the server 140 is used to offer a “public platform” and other IM services.

In a conventional IM system, if a user desires to distribute a graphic message, he has to edit the graphic message himself. The editing process involves a lot of complicated works such as image processing, art design, layout planning, which costs much time and requires much skills for the user.

In contrast to this, various examples of the present disclosure provide a method for generating a graphic message for an IM user, in which the IM user is released from the complicated editing operations. Instead, the IM user only needs to input the contents he wants to distribute. The IM server or the IM client application automatically generates the message to be distributed according to a user type of the IM user and the contents inputted by the IM user.

Hereinafter, the method provided by various examples of the present disclosure will be described more fully with reference to the network computer system 100. In the following examples of the present disclosure, a public user which accesses the Internet 130 via the public platform provided by the server 140 is taken as an exemplary IM user.

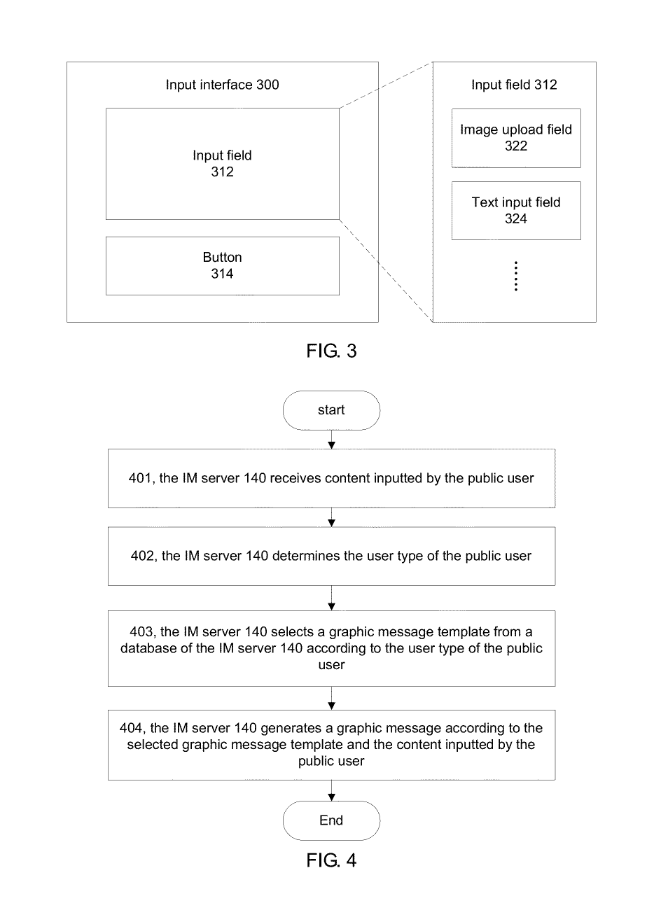

FIG. 2 illustrates a public platform interface 114 displayed on the client device 110 during run-time environment. The public platform interface 114 may contain an input interface. FIG. 3 illustrates an input interface 300 for graphic message according to an example of the present disclosure. The input interface 300 may display an input field 312 and a button 314. The public user may input content in the input field 312 to generate a graphic message to be distributed. As shown in FIG. 3, the entry field 312 may include an image upload field 322 and a text input field 324. The public user may upload an image in the image upload field 322 and input text in the text input field 324. In a practical application, besides the image upload field 322 and the text input field 324, the input field 312 may further include other fields, such as a title field, an abstract field, a link field, etc.

After inputting the content in the input field 312, the public user may click the button 314 to trigger the client device 110 to transmit the content inputted by the public user to the IM server 140. The IM server 140 then automatically generates a graphic message according to the user type of the public user and the contents inputted by the public user.

In addition, the input interface 300 may further include a preview button through which the public user may see a preview of the graphic message to be distributed. If the public user likes what he sees, he can then click the button 314 to trigger the distribution of the graphic message.

FIG. 4 illustrates a method for generating a graphic message in instant messaging in accordance with an example of the present disclosure. It should be noted that some functions of the procedure shown in FIG. 4 are not necessarily essential for implementing the present disclosure.

At block 401, the IM server 140 receives content inputted by the public user.

In this block, the content refers to the content inputted by the public user in the input field 312. The content may be any one or any combination of image, text, video, audio, link, etc. For example, if the public user is an online retailer, the content inputted by the online retailer may include descriptions, prices, purchase links and pictures of commodities. If a private user chicks the purchase link of a commodity in the graphic message, it is jumped to a purchase page of the commodity. On that page, some detailed descriptions, comments of other buyers, carriage of the commodity may be displayed. For another example, if the public user is a network game provider, the content inputted by the network game provider may include a representative picture of network game and the network game. Once a private user sees this graphic message, he can download the network game through clicking a link in the graphic message. In addition, the public user may also upload a video clip or a piece of music in the input field 312. At this time, after the private user opens the graphic message containing the video clip or music, the video clip or the music may be played for the private user automatically.

At block 402, the IM server 140 determines the user type of the public user.

In this block, the user type may include company, brand, celebrity, online retailer, etc. These different types of public users may have different requirements when distributing messages. For instance, messages distributed by an online retailer and a celebrity may both have many pictures. For example, the online retailer may have pictures for his commodities. The celebrity may have pictures for some news. But the online retailer may want the pictures of commodities to be displayed with the same or similar size, whereas the celebrity may want one picture displayed bigger than others to attract eyes. Therefore, it is necessary to use different kinds of graphic message templates for these different kinds of the public users. For another example, a music public user may wish songs in his graphic message be played automatically when the private user sees the graphic message. For a network game public user, the network game may be downloaded to the client device of the private user when the private user clicks the link contained in the graphic message.

In view of the above, different types of public users may have different requirements when distributing a graphic message. Therefore, the IM server 140 should store various kinds of graphic message templates for each type of public user.

In one implementation, the public user may register type information on the public platform provided by the IM server 140 during registration procedure. The type information of the public user indicates the user type of the public user. In this example, the registered user type may be recorded in profile data of the public user in the IM server 140.

Thus, after receiving the content inputted by the public user, the IM server 140 may determine the user type of the public user according to the registered type information recorded in the profile data of the public user in the IM server 140.

At block 403, the IM server 140 selects a graphic message template from a database of the IM server 140 according to the user type of the public user.

In one example, the IM server 140 may store various kinds of graphic message templates for different user types in the database of the IM server 140 in advance.

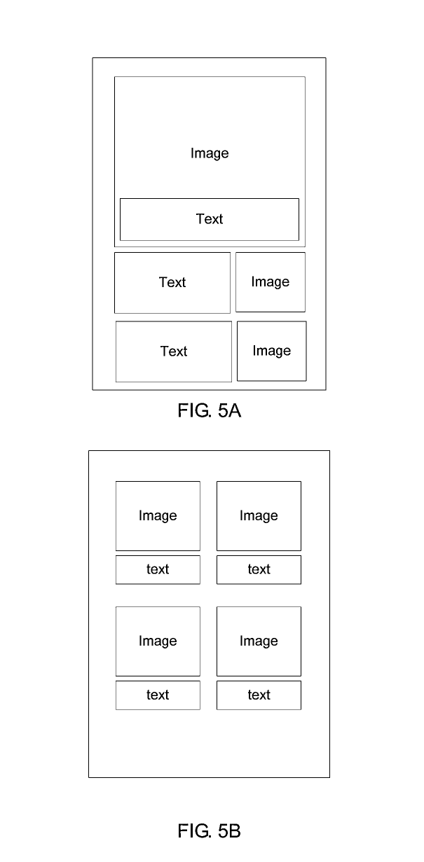

For example, if it is determined in block 402 that the public user is a celebrity, the IM server 140 may select a celebrity template to generate a graphic message for the celebrity. In the celebrity template, the content inputted by the celebrity may be displayed as show in FIG. 5A. As shown in FIG. 5A, the pictures uploaded by the celebrity are arranged differently. Typically, the first picture is displayed with a bigger size than others to attract eyes, whereas other pictures are displayed with relatively small size. In the case that the celebrity uploads only one picture, the IM server 140 may further generate an abstract automatically according to the text inputted by the celebrity in the text input field 324. In addition, the title (if any) for the first picture in the celebrity template may be overlapped with the first picture to save space.

If the public user is an online retailer, a retailer template may be selected by the IM server to generate a graphic message. FIG. 5B illustrates a retailer template for generating a graphic message in accordance with an example of the present disclosure. As shown in FIG. 5B, the pictures uploaded by the online retailer are arranged with the same relatively small size. The text inputted by the public user is displayed around the picture, e.g., below the picture.

In addition, in the case that the input field 312 includes a link input field, the public user may further input a link. At this time, after receiving the content inputted by the public user, the IM server 140 may further arrange the link in the graphic message template. A private user who receives the graphic message may click the link to jump to a page corresponding to the link. The link may be arranged separately (e.g., displaying words such as “click for whole document” in the graphic message) or in combination with other fields (e.g., the private user may click the text displayed in the graphic message to jump to the page corresponding to the link).

In another example, if the public user is a network game public user, the graphic message template for the network game public user may contain a representative picture of the network game and network game, i.e., the network public user only needs to upload materials such as the representative picture and the network game in the input field 312. Then, the IM server 140 automatically generates a graphic message containing the representative picture and a link for downloading the network game.

In a practical application, those skilled in the art may configure other graphic message templates which are also within the protection scope of the present disclosure.

At block 404, the IM server 140 generates a graphic message according to the selected graphic message template and the content inputted by the public user.

In this block, the IM server 140 may fill the graphic message template with the content inputted by the public user.

For the online retailer, the IM server 140 fills the pictures, text uploaded by the online retailer in the retailer template according to a rule that each picture is displayed with an average size. For the celebrity, the IM server 140 fills the pictures and text inputted by the celebrity in the celebrity template according to a rule that one of the pictures is displayed with a bigger size.

The detailed method for filling the graphic message template may be well-known for those skilled in the art, thus is not described herein.

In addition, the IM server 140 may generate a link for the materials uploaded by the public user and fill the link in the graphic message template.

For example, for a network game public user, the IM server 140 generates a link for downloading the network game, and fills in the network game template with the link generated and the representative picture uploaded by the network game public user. For another example, if a public user uploads a video file and/or audio file in the input field 312, the IM server 140 may embed the upload video file and/or audio file in the selected graphic message template to generate the graphic message. In this case, the selected graphic message template may display a brief description of the video file and/or audio file. After receiving the graphic message, the embedded audio file and/or video file may be played to the private user automatically.

The above merely describes some examples of the present disclosure. For other kinds of graphic message templates, one skilled in the art may configure rules for generating graphic messages according to corresponding graphic message templates.

Now, the procedure shown in FIG. 4 ends. After generating the graphic message, the IM server 140 may transmit the generated graphic message to receivers designated by the public user. For example, if the public user is a small hamburger shop, he may wish to distribute an advertisement to his buddies via the IM server 140. In a conventional system, he has to generate this advertisement by his own, which involves a lot of complicated image editing and layout planning works. In the network computer system 100 of the present disclosure, the small hamburger shop only needs to upload materials for generating the advertisement to the IM server 140. Then, the IM server 140 will automatically generate an advertisement (i.e., a graphic message) for the small hamburger shop. He may preview the generated advertisement and distribute it to his buddies if he likes what he sees.

According to the method shown in FIG. 4, the IM server 140 automatically selects a graphic message template for the public user to generate the graphic message to be distributed. Thus, the public user is released from the complicated image edition works and other layout design works. The experience of the public user is improved.

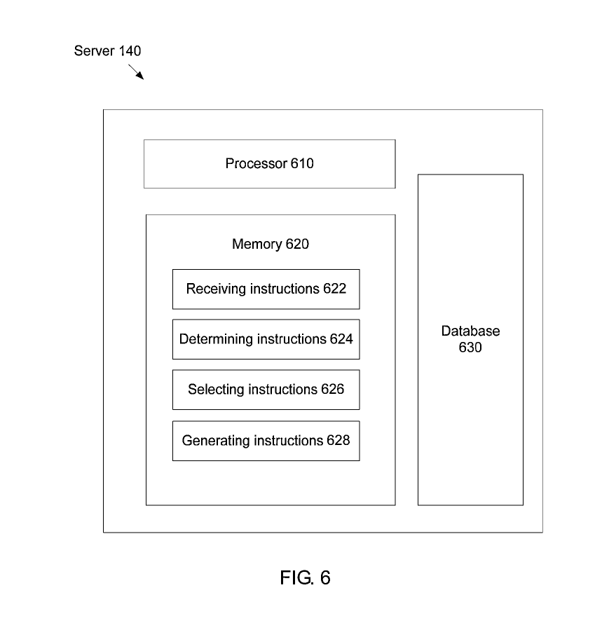

In accordance with the above method, various examples of the present disclosure further provide an IM server 140 for generating a graphic message in instant messaging. FIG. 6 is a schematic diagram illustrating an IM server 140 for generating a graphic message in instant messaging in accordance with an example of the present disclosure.

As shown in FIG. 6, the IM server 140 may include at least one Central Processing Unit (CPU) or a processor 610, a memory 620 and a database 630. Note that the IM server 140 may further include a network interface, a display interface and so on. Various modifications, additions or deletions may be made to the IM server 140 illustrated in FIG. 6 within the scope of the present disclosure.

Processor 610 performs computation and control functions of the IM server 140. Processor 610 may include a single integrated circuit, such as a microprocessor, or may include any suitable number of integrated circuit devices and/or circuit boards working in cooperation to accomplish the functions of a processor or a CPU. The processor 610 is configured to execute one or more software programs contained in the memory 620.

The memory 620 includes:

receiving instructions 622, for receiving content inputted by a public user;

determining instructions 624, for determining a user type of the public user;

selecting instructions 626, for selecting from the database 630 a graphic message template for the public user according to the user type determined by the determining instructions 624; and

generating instructions 628, for generating a graphic message according to the graphic message template and the content inputted by the public user.

The database 630 stores various kinds of graphic message template for different user types. The graphic message templates have been described above with reference to the method shown in FIG. 4 and will not be repeated herein.

The memory 620 may further include machine readable instructions executable by the processor to:

record type information of the public user in the IM server when the public user registers on the IM server; and

determine the user type of the public user according to the type information recorded in the IM server.

The memory 620 may further include machine readable instructions executable by the processor to:

generate, if the content inputted by the public user comprises an application, a link for downloading the application; and

fill the generated link in the selected graphic message template to generate the graphic message.

The memory 620 may further include machine readable instructions executable by the processor to:

if the content inputted by the public user comprises a video file and/or audio file, embed the video file and/or audio file in the selected graphic message template to generate the graphic message.

The memory 620 may further include machine readable instructions executable by the processor to:

transmit the graphic message generated to at least one receivers designated by the public user.

The memory 620 may further store data and programs such as an operating system and one or more application programs.

The IM server 140 may further include an input/output interface which enables wired or wireless connection to various devices for receiving information from and transmitting information to users or these devices.

Detailed functions of the IM server 140 have been described above with reference to the procedure as shown in FIG. 2 to FIG. 5 and will not be repeated herein.

In various examples of the present invention, the IM application may include WeChat, QQ, ICQ, MSN Messenger, Skype, Fetion, AIM, GoogleTalk, MyspaceIM, Sametime, Gadu Gadu, etc. Accordingly, the network computer system 100 may be a system implementing any one of the above listed IM applications.

In the above examples of the present disclosure, the public user is taken as the exemplary IM user. It should be noted that, the solution of the present invention is also applicable for private users. For a private user, an IM application installed in the client device of the private user may provide an input interface to the private user and select a graphic message template for the private user according to the user type of the private user. Then, the IM application installed in the client device of the private user automatically generates a graphic message according to the materials inputted by the private user in the input interface and the selected graphic message template. The detailed implementation may be similar to those described above with reference to the public user, only some functions performed by the IM server may be realized by the IM application installed in the client device in this example.

As will be appreciated by one skilled in the art, aspects of the disclosed network computer system 100 disclosed herein may be embodied as a system, method or computer program product. Accordingly, aspects of the network computer system may take the form of an hardware embodiment, an software embodiment or an embodiment combining software and hardware aspects that may all generally be referred to herein as a “circuit”, “module” or “system”. Furthermore, aspects of the network computer system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A computer-implemented method for generating a graphic message in instant messaging (IM), comprising:
receiving, by an IM server, content inputted by an IM user;
determining, by the IM server, user type of the IM user;
selecting, by the IM server, a graphic message template from a database of the IM server according to the user type of the IM user; and
generating, by the IM server, a graphic message to be distributed according to the selected graphic message template and the content inputted by the IM user.

2. The computer-implemented method of claim 1, further comprising:
recording, by the IM server, type information of the IM user in the IM server when the IM user registers on the IM server; and
the determining the user type of the IM user comprises: determining, by the IM server, the user type of the IM user according to the type information recorded in the IM server.

3. The computer-implemented method of claim 1, wherein the content inputted by the IM user comprises an application;
the generating the graphic message to be distributed according to the selected graphic message template and the content inputted by the IM user comprises:
generating, by the IM server, a link for downloading the application; and
filling, by the IM server, the generated link in the selected graphic message template to generate the graphic message.

4. The computer-implemented method of claim 1, wherein the content inputted by the IM user comprises a video file and/or audio file;
the generating the graphic message to be distributed according to the selected graphic message template and the content inputted by the IM user comprises:
embedding the video file and/or audio file in the selected graphic message template to generate the graphic message.

5. The computer-implemented method of claim 1, wherein the content inputted by the IM user comprises a plurality of pictures;
in the selected graphic message template, one of the plurality of pictures is arranged with a bigger size than other pictures.

6. The computer-implemented method of claim 1, wherein the content inputted by the IM user comprises a plurality of pictures;
in the selected graphic message template, the plurality of pictures are arranged with the same size.

7. The computer-implemented method of claim 1, further comprising:
transmitting, by the IM server, the graphic message generated to at least one receivers designated by the IM user.

8. An instant messaging (IM) server for generating a graphic message, comprising a processor, a memory and a database; the memory and the database are coupled to the processor, wherein the database stores at least one graphic message template, the memory comprises machine readable instructions executable by the processor to:
receive content inputted by an IM user;
determine user type of the IM user;
select a graphic message template from the database according to the user type of the IM user; and
generate a graphic message to be distributed according to the selected graphic message template and the content inputted by the IM user.

9. The IM server of claim 8, wherein the memory further comprises machine readable instructions executable by the processor to:
record type information of the IM user in the IM server when the IM user registers on the IM server; and
determine the user type of the IM user according to the type information recorded in the IM server.

10. The IM server of claim 8, wherein the memory further comprises machine readable instructions executable by the processor to:
generate, if the content inputted by the IM user comprises an application, a link for downloading the application; and
fill the generated link in the selected graphic message template to generate the graphic message.

11. The IM server of claim 8, wherein the memory further comprises machine readable instructions executable by the processor to:
if the content inputted by the IM user comprises a video file and/or audio file, embed the video file and/or audio file in the selected graphic message template to generate the graphic message.

12. The IM server of claim 8, wherein the content inputted by the IM user comprises a plurality of pictures;
in the selected graphic message template, one of the plurality of pictures is arranged with a bigger size than other pictures.

13. The IM server of claim 8, wherein the content inputted by the IM user comprises a plurality of pictures;
in the selected graphic message template, the plurality of pictures are arranged with the same size.

14. The IM server of claim 8, wherein the memory further comprises machine readable instructions executable by the processor to:
transmit the graphic message generated to at least one receivers designated by the IM user.

15. A non-transitory computer readable storage medium storing one or more programs, which when executed by a processor, perform the steps of:
receiving, by an IM server, content inputted by an IM user;
determining, by the IM server, user type of the IM user;
selecting, by the IM server, a graphic message template from a database of the IM server according to the user type of the IM user; and
generating, by the IM server, a graphic message to be distributed according to the selected graphic message template and the content inputted by the IM user.

16. The non-transitory computer readable storage medium of claim 15, further comprising instructions for:
recording type information of the IM user in the IM server when the public user registers on the IM server; and
determining the user type of the IM user according to the type information recorded in the IM server.

17. The non-transitory computer readable storage medium of claim 15, further comprising instructions for:
generating, if the content inputted by the IM user comprises an application, a link for downloading the application; and
filling the generated link in the selected graphic message template to generate the graphic message.

18. The non-transitory computer readable storage medium of claim 15, further comprising instructions for:
if the content inputted by the IM user comprises a video file and/or audio file, embedding the video file and/or audio file in the selected graphic message template to generate the graphic message.

19. The non-transitory computer readable storage medium of claim 15, wherein the content inputted by the IM user comprises a plurality of pictures;
in the selected graphic message template, one of the plurality of pictures is arranged with a bigger size than other pictures.

20. The non-transitory computer readable storage medium of claim 15, wherein the content inputted by the IM user comprises a plurality of pictures;
in the selected graphic message template, the plurality of pictures are arranged with the same size.

21. The non-transitory computer readable storage medium of claim 15, further comprising instructions for:
transmitting the graphic message generated to at least one receivers designated by the IM user.
